(19) United States
(12) Patent Application Publication
(10) Pub. No.: US 2004/0225487 A1
(43) Pub. Date: Nov. 11, 2004

(54) Power supply noise analysis model generator, power supply noise analysis model generation method, and power supply noise analysis model generation program

(75) Inventors: Yoshiyuki Iwakura, Kawasaki (JP); Toshiaki Sato, Kawasaki (JP); Kazuyoshi Kanei, Kawasaki (JP); Hitoshi Chida, Kawasaki (JP); Kotaro Nimura, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/786,315

(22) Filed: Feb. 26, 2004

(30) Foreign Application Priority Data
May 9, 2003 (JP) 2003-131529

(51) Int. Cl. G06F 17/50

(52) U.S. Cl. 703/18

(57) ABSTRACT

A power supply noise analysis model generator models power supply layers in circuit boards, and includes: a CAD data obtaining section that obtains CAD data; a CAD data conversion section that converts CAD data into data suitable for noise analysis; a power supply pair extraction section that extracts a power supply pair; a mesh division section that divides a power supply pair region into meshes; a ripple processing section that arranges ripples as wave fronts of electromagnetic waves radiated into the power supply pair region from elements thereon; a node layout section that positions plural nodes on the power supply pair region; a node region determination section that determines node regions; an LRC determination section that determines L, R and C connecting the nodes; a power supply layer model generation section that generates a power supply layer model; and a power supply noise analysis model generation section that generates a power supply noise analysis model.

### BACKGROUND OF THE INVENTION

1. Field of the Invention

The present invention relates to a power supply noise analysis model generator, a power supply noise analysis model generation method, and a power supply noise analysis model generation program, which model power supply layers for analyzing power supply noise created in a circuit board.

2. Description of the Related Art

In recent circuit designs, elements mounted on a circuit have become higher and higher in density so that the density of power supply current per unit area of circuit boards tends to increase remarkably. In addition, as the operating frequency of circuit boards has increased, frequency components contained in the power supply current have become higher. From these circumstances, the number of problems caused by power supply noise has been increasing although the power supply noise had been negligible problems before. In a conventional means for analyzing power supply noise, the amount of noise is calculated by modeling the entire circuit board and by using a circuit simulator. A typical circuit simulator is, for example, SPICE (Simulation Program with Integrated Circuit Emphasis).

There has been known a method of modeling a circuit board in which the circuit board is modeled in the form of a donut instead of dividing the circuit board into uniform meshes, in order to prevent decrease in simulation speed (for example, see Japanese Patent Application Laid-Open No. 2000-2752 (pages 6 to 10, and FIG. 1)).

In the prior art, modeling is performed dividing the entire circuit board into uniform meshes. Therefore, if conditions are given such that the density of elements mounted on a circuit board is biased or non-uniform or a power supply is divided, these conditions are not taken into consideration in the modeling. Consequently, power supply noise analysis with high accuracy cannot be performed in this modeling of uniform meshes.

### SUMMARY OF THE INVENTION

Accordingly, the present invention has been made in view of the above problems, and has for its object to provide a power supply noise analysis model generator, a power supply noise analysis model generation method, and a power supply noise analysis model generation program in which power supply layers are modeled in consideration of various conditions of circuit boards in order to achieve accurate power supply noise analysis close to actual operations of circuit boards.

To achieve the above object, according to one aspect of the present invention, there is provided a power supply noise analysis model generator for modeling power supply layers in a circuit board, the generator comprising: a CAD data obtaining section that obtains CAD data including information concerning a board shape, pattern shapes, and elements; a CAD data conversion processing section that converts the CAD data into power supply island pattern data, element data, lead pattern data, and via pattern data; a power supply pair extraction processing section that extracts, if two power supply islands existing respectively in two different power supply layers overlap each other, the two power supply islands as a power supply pair; a node layout processing section that positions plural nodes on a power supply pair region which is occupied by the power supply pair on a plane of the circuit board; a node region determination processing section that determines node regions respectively surrounding the nodes; an impedance parameter determination processing section that determines impedance parameters respectively expressing relationships between the nodes; a power supply layer model generation processing section that connects the nodes to each other using the impedance parameters thereby to generate a power supply layer model; and a power supply noise analysis model generation processing section that connects the power supply layer model, the lead pattern data, and the via pattern data thereby to generate a power supply noise analysis model.

According to this configuration, a power supply noise analysis model in consideration of the influences from electric and magnetic fields is generated based on a power supply pair constituted by two power supply islands existing different power supply layers. Therefore, before manufacturing a circuit board, it is possible to perform power supply noise analysis with high accuracy, which is close to the actual operation of the circuit board. In one embodiment, the impedance parameter determination processing section in this configuration corresponds to an LRC determination processing section 20.

Preferably, in the power supply noise analysis model generator according to the present invention, the impedance parameters may be a reactance L, a resistance R, and an interlayer capacitance C. According to this configuration, influences from power supply layers can be expressed as a model usable by a circuit simulator.

Preferably, in the power supply noise analysis model generator according to the present invention, if a power supply pair space sandwiched between power supplies of an observed power supply pair is contacted by or overlapped by another power supply pair space of any other power supply pair, the power supply pair extraction processing section may group the observed power supply pair and the other power supply pair into a group.

According to this configuration, the accuracy of power supply noise analysis can be improved by power supply pairs whose electric and magnetic fields influence each other are grouped.

Preferably, the power supply noise analysis model generator according to the present invention may further comprise a ripple processing section that positions, on the power supply pair region, ripples which are wave fronts of electromagnetic waves radiated into the power supply pair region from the elements, in which the node layout processing section may position the nodes, based on pitches of the ripples.

According to this configuration, a model taking the influences from electromagnetic waves into consideration can be generated, so that the accuracy of the power supply noise analysis can be improved.

Preferably, in the power supply noise analysis model generator according to the present invention, the ripple processing section may use rising or falling times of those of the elements that are mounted on the power supply pair region, maximum operating frequencies of those elements, and areas of the ripples, to calculate intervals between the ripples. According to this configuration, the wave fronts of electromagnetic waves can be calculated at a high speed with high accuracy.

Preferably, in the power supply noise analysis model generator according to the present invention, the ripple processing section may spread the ripples into power supply pair regions of power supply pairs which belong to a group.

According to this configuration, the accuracy of power supply noise analysis can be improved by considering the influences which a plurality of power supply pairs make on each other.

Preferably, the power supply noise analysis model generator according to the present invention may further comprise a ripple display processing section that searches for outline coordinates of the ripples, and displays the ripples with the use of the outline coordinates.

According to this configuration, the coordinates of ripple outlines are obtained and the outlines are drawn together at once, when ripples are displayed as figures. The drawing time can hence be shortened.

Preferably, the power supply noise analysis model generator according to the present invention may further comprise a mesh division processing section that divides the power supply pair region with the use of meshes based on a wavelength of one of the elements mounted that has the highest operating frequency.

According to this structure, the power supply pair region is divided by optimal meshes, so that the power supply noise analysis can be performed at a high speed.

Preferably, the power supply noise analysis model generator according to the present invention may further comprise an internal data storage that stores information for every of the meshes, into a table on which coordinates on the circuit board correspond to addresses.

According to this structure, the data necessary for the power supply layer model can be stored efficiently.

Preferably, in the power supply noise analysis model generator according to the present invention, the information for every of the meshes includes at least one of a ripple level which indicates the number of ripples from an element to a corresponding mesh, the presence or absence of a node in the corresponding mesh, and a node region identifier expressing a node region to which the corresponding mesh belongs.

According to this configuration, information for every mesh is stored, corresponding to coordinates, so that ripples, nodes, and node regions can be easily searched for.

Preferably, in the power supply noise analysis model generator according to the present invention, taking a most adjacent node as the node closest to an observed node within a sector having a predetermined radius about the observed node as the center of the sector, the node region determination processing section may search for adjacent nodes, rotating the sector about the observed node. According to this configuration, the adjacent nodes used for determining the node regions can be searched for efficiently.

Preferably, in the power supply noise analysis model generator according to the present invention, the node region determination processing section may remove a square from the power supply pair region thereby to determine an edge of the node region of the observed node with respect to the most adjacent node, the square having as an edge a perpendicular bisector of a predetermined length between the observed node and the most adjacent node and containing the most adjacent node, so that edges of the node region of the observed node are sequentially determined with respect to all the adjacent nodes, respectively, in the order of increasing distance from said most adjacent node, finally to determine the node region of the observed node. According to this structure, the node regions of the nodes which are irregularly arranged can be determined efficiently.

Preferably, in the power supply noise analysis model generator according to the present invention, the impedance parameter determination processing section may determine L and R based on distances between the nodes, and determine C with the use of the areas of the node regions and a distance or distances between power supply layers, and the power supply layer model generation processing section may arrange the L and R between the nodes on an upper surface of the power supply pair and between the nodes on a lower surface of the power supply pair, and arrange each C between such a couple of the nodes that are arranged at equal positions respectively on the upper and lower surfaces of the power supply pair. According to this configuration, the power supply layers can be expressed as a model suitable for circuit simulation.

Preferably, the power supply noise analysis model generator according to the present invention may further comprise a power supply noise analysis model storage that stores the power supply noise analysis model. According to this configuration, the circuit simulator can analyze power supply noise by using the power supply noise analysis model stored in the power supply noise analysis model storage.

Preferably, in the power supply noise analysis model generator according to the present invention, the power supply noise analysis model generation processing section may further generate a total circuit model in which the power supply noise analysis model is connected to the element data, and store the total circuit model into the power supply noise analysis model storage. According to this structure, the circuit simulator can simulate the total circuit taking the power supply noise analysis into consideration with the use of the total circuit model stored in the power supply noise analysis model storage.

According to another aspect of the present invention, there is provided a power supply noise analysis model generator which models a power supply layer in a circuit board, the generator comprising: a power supply pair extraction processing section that extracts, as a power supply pair, different two power supply layers overlapping each other in a layering direction from data indicative of the circuit board; and a power supply noise analysis model generation processing section that uses the power supply pair extracted to generate a power supply noise analysis model.

According to a further aspect of the present invention, there is provided a power supply noise analysis model generation method of modeling power supply layers in a circuit board, the method comprising: a step of obtaining CAD data including information concerning a board shape, pattern shapes, and elements; a step of converting the CAD data into power supply island pattern data, element data, lead pattern data, and via pattern data; a step of extracting, if two power supply islands existing respectively in two different layers overlap each other, the two power supply islands as a power supply pair; a step of positioning plural nodes on a power supply pair region which is occupied by the power supply pair on a plane of the circuit board; a step of determining node regions respectively surrounding the nodes; a step of determining impedance parameters respectively expressing relationships between the nodes; a step of connecting the nodes to each other using the impedance parameters, to generate a power supply layer model; and a step of connecting the power supply layer model, the lead pattern data, and the via pattern data, to generate a power supply noise analysis model.

According to this configuration, a power supply noise analysis model taking the influences from electric and magnetic fields into consideration is generated based on a power supply pair constituted by two power supply islands existing different power supply layers. Therefore, before manufacturing a circuit board, it is possible to perform power supply noise analysis with high accuracy, which is close to the actual operation of the circuit board.

Preferably, in the power supply noise analysis model generation method according to the present invention, the impedance parameters may be a reactance L, a resistance R and an interlayer capacitance C, and the influences from power supply layers can be expressed as a model usable by a circuit simulator.

Preferably, in the power supply noise analysis model generation method according to the present invention, if a power supply pair space sandwiched between power supplies of an observed power supply pair is contacted by or overlapped by another power supply pair space of any other power supply pair, the observed power supply pair and the other power supply pair may be grouped into a group, in the step of extracting the power supply pair. Thus, the accuracy of power supply noise analysis can be improved by power supply pairs whose electric and magnetic fields influence each other are grouped.

Preferably, the power supply noise analysis model generation method according to the present invention may further comprise a step of positioning, on the power supply pair region, ripples which are wave fronts of electromagnetic waves radiated into the power supply pair region from the elements, wherein in the step of positioning the plural nodes, the nodes may be positioned based on pitches of the ripples. Thus, a model considering the influences from electromagnetic waves can be generated, so that the accuracy of the power supply noise analysis can be improved.

Preferably, in the power supply noise analysis model generation method according to the present invention, rising or falling times of those of the elements that are mounted on the power supply pair region, maximum operating frequencies of those elements, and areas of regions of the ripples may be used to calculate the ripples, in the step of positioning the ripples. Thus, the wave fronts of electromagnetic waves can be calculated with high accuracy at a high speed.

Preferably, in the power supply noise analysis model generation method according to the present invention, the ripples may be spread into power supply pair regions of power supply pairs which belong to a group, in the step of positioning the ripples. Thus, the accuracy of power supply noise analysis can be improved by considering the influences which a plurality of power supply pairs make on each other.

Preferably, the power supply noise analysis model generation method according to the present invention may further comprise a step of searching for outline coordinates of the ripples, and displaying the ripples with the use of the outline coordinates. Thus, the coordinates of ripple outlines are obtained and the outlines are drawn together at once, when ripples are displayed as figures. The drawing time can hence be shortened.

Preferably, the power supply noise analysis model generation method according to the present invention may further comprise a step of dividing the power supply pair region with the use of meshes based on a wavelength of one of the elements mounted that has the highest operating frequency. Thus, the power supply pair region is divided by optimal meshes, so that the power supply noise analysis can be performed at a high speed.

Preferably, the power supply noise analysis model generation method according to the present invention may further comprise a step of storing information for every of the meshes, into a table on which coordinates on the circuit board correspond to addresses. Thus, the data necessary for the power supply layer model can be stored efficiently.

Preferably, in the power supply noise analysis model generation method according to the present invention, the information for every of the meshes may include at least one of a ripple level which indicates the number of ripples from an element to a corresponding mesh, the presence or absence of a node in the corresponding mesh, and a node region identifier expressing a node region to which the corresponding mesh belongs. Thus, information for every mesh is stored in correspondence with coordinates, so that ripples, nodes, and node regions can be easily searched for.

According to a still further aspect of the present invention, there is provided a power supply noise analysis model generation method of modeling a power supply layer in a circuit board, the method comprising: a step of extracting, as a power supply pair, different two power supply layers overlapping each other in a layering direction from data indicative of the circuit board; and a step of using the power supply pair extracted, to generate a power supply noise analysis model.

According to a yet further aspect of the present invention, there is provided a power supply noise analysis model generation program which is stored in a medium readable by a computer to make the computer execute modeling power supply layers in a circuit board, the program being operable to make the computer execute: a step of obtaining CAD data including information concerning a board shape, pattern shapes, and elements; a step of converting the CAD data into power supply island pattern data, element data, lead pattern data, and via pattern data; a step of extracting, if two power supply islands existing respectively in two different layers overlap each other, the two power supply islands as a power supply pair; a step of positioning plural nodes on a power supply pair region which is occupied by the power supply pair on a plane of the circuit board; a step of determining node regions respectively surrounding the nodes; a step of determining impedance parameters respectively expressing relationships between the nodes; a step of connecting the nodes to each other using the impedance parameters, to generate a power supply layer model; and a step of connecting the power supply layer model, the lead pattern data, and the via pattern data, to generate a power supply noise analysis model.

According to this configuration, a power supply noise analysis model taking the influences from electric and magnetic fields into consideration is generated based on a power supply pair constituted by two power supply islands existing different power supply layers. Therefore, before manufacturing a circuit board, it is possible to perform power supply noise analysis with high accuracy, which is close to the actual operation of the circuit board.

Preferably, the impedance parameters may be a reactance L, a resistance R, and an interlayer capacitance C. Also, in the power supply noise analysis model generation program according to the present invention, if a power supply pair space sandwiched between power supplies of an observed power supply pair is contacted by or overlapped by another power supply pair space of any other power supply pair, the observed power supply pair and the other power supply pair may be grouped into a group, in the step of extracting the power supply pair.

Preferably, the power supply noise analysis model generation program according to the present invention may further comprise a step of making the computer execute positioning, on the power supply pair region, ripples which are wave fronts of electromagnetic waves radiated into the power supply pair region from the elements, wherein in the step of positioning the plural nodes, the nodes may be positioned based on pitches of the ripples.

Preferably, in the power supply noise analysis model generation program according to the present invention, rising or failing times of those of the elements that are mounted on the power supply pair region, maximum operating frequencies of those elements, and areas of regions of the ripples may be used to calculate the ripples, in the step of positioning the ripples. Also, in the power supply noise analysis model generation program according to the present invention, the ripples may be spread into power supply pair regions of power supply pairs which belong to a group, in the step of positioning the ripples.

Preferably, the power supply noise analysis model generation program according to the present invention may further comprise a step of making the computer execute searching for outline coordinates of the ripples, and displaying the ripples with the use of the outline coordinates.

Preferably, the power supply noise analysis model generation program according to the present invention may further comprise a step of making the computer execute dividing the power supply pair region with the use of meshes based on a wavelength of one of the elements mounted that has the highest operating frequency.

Preferably, the power supply noise analysis model generation program according to the present invention may further comprise a step of making the computer execute storing information for every of the meshes, into a table on which coordinates on the circuit board correspond to addresses.

Preferably, in the power supply noise analysis model generation program according to the present invention, the information for every of the meshes may include at least one of a ripple level which indicates the number of ripples from an element to a corresponding mesh, the presence or absence of a node in the corresponding mesh, and a node region identifier expressing a node region to which the corresponding mesh belongs.

According to a further aspect of the present invention, there is provided a power supply noise analysis model generation program which is stored in a medium readable by a computer to make the computer execute modeling a power supply layer in a circuit board, the program being operable to make the computer execute: a step of extracting, as a power supply pair, different two power supply layers overlapping each other in a layering direction from data indicative of the circuit board; and a step of using the power supply pair extracted, to generate a power supply noise analysis model.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram showing an example of the configuration of a circuit design system;

FIGS. 2A and 2B are a plan view and a cross sectional view, respectively, of an example of the configuration of a circuit board as a target to be modeled by a power supply noise analysis model generator according to the present invention;

FIG. 3 is a block diagram showing an example of the hardware configuration of the power supply noise analysis model generator according to the present invention;

FIG. 4 is a block diagram showing an example of the software configuration of the power supply noise analysis model generator according to the present invention;

FIG. 5 is a flowchart showing a processing of the power supply noise analysis model generator according to the present invention;

FIG. 6 is a cross-sectional view showing an example of a power supply pair according to the present invention;

FIG. 7 is a flowchart showing the flow of a power supply pair extraction processing according to the present invention;

FIGS. 8A and 8B are a plan view and a cross sectional view, respectively, of an example of the configuration of a circuit board having plural power supply islands in power supply layers according to the present invention;

FIGS. 9A through 9C show cross sectional views of an example of the power supply pair extraction processing according to the present invention;

FIGS. 10A and 10B show a plan view and a cross sectional view, respectively, of an example of the configuration of a circuit board having plural power supply islands surrounded by power supply layers according to the present invention;

FIGS. 11A through 11C show a cross sectional view, a plan view and a cross sectional view, respectively, of another example of the power supply pair extraction processing according to the present invention;

FIG. 12 is a cross sectional view showing influences from electromagnetic waves on adjacent power supply pair spaces according to the present invention.

FIG. 13 is a flowchart showing the flow of a power supply pair group extraction processing according to the present invention;

FIGS. 14A through 14C are a cross sectional view and plan views, respectively, of an example of results of calculating a power supply pair region according to the present invention;

FIG. 15 is a flowchart showing the flow of a ripple processing according to the present invention;

FIG. 16 is a plan view showing an example of results of calculating a first ripple according to the present invention;

FIG. 17 is a plan view showing an example of results of calculating third ripples according to the present invention;

FIG. 18 is a flowchart showing the flow of a ripple display processing according to the present invention;

FIGS. 19A through 19D show diagrams explaining inspection orders in respective search directions according to the present invention;

FIGS. 20A through 20G show diagrams explaining positions of outline coordinates according to the present invention;

FIG. 21 is a view showing a relationship between current points and an origin point according to the present invention;

FIG. 22 is a plan view showing an example of mesh regions where nodes are arranged according to the present invention;

FIG. 23 is a flowchart showing the flow of a node region determination processing according to the present invention;

FIG. 24 is a view showing an example of a rectangular region surrounding a target region according to the present invention;

FIG. 25 is a view showing an example of a search area for adjacent nodes according to the present invention;

FIGS. 26A through 26C show views of a specific example of the node region determination processing with respect to an observed node according to the present invention;

FIG. 27 is a view showing an example of node regions assigned to a power supply pair region according to the present invention; and

FIG. 28 is a view showing an example of a power supply layer model according to the present invention.

### DESCRIPTION OF THE PREFERRED EMBODIMENTS

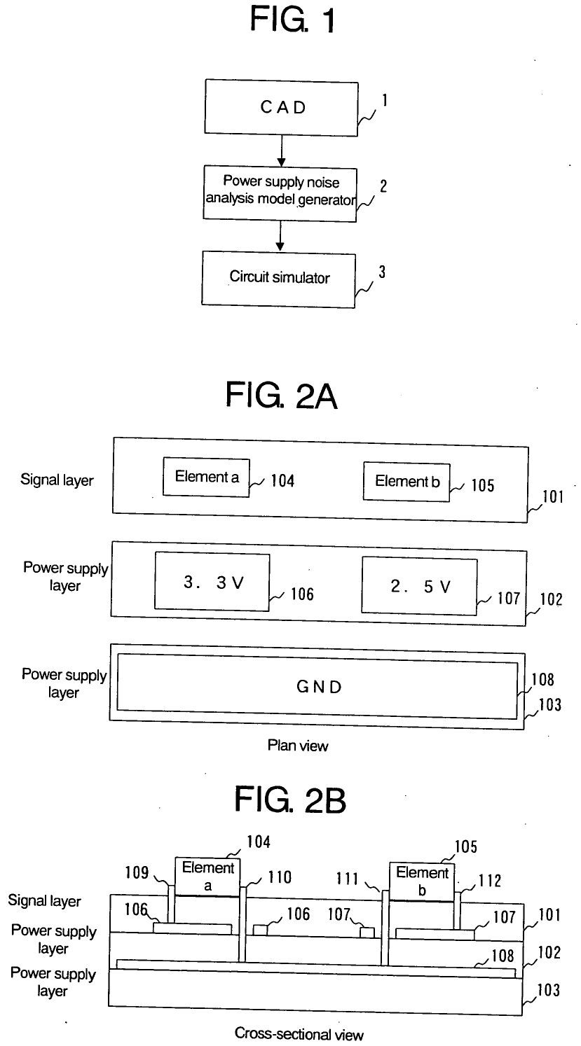

Hereinafter, preferred embodiments of the present invention will be described in detail with reference to the accompanying drawings. At first, the configuration of a circuit design system will be described. FIG. 1 is a block diagram showing a configuration example of a circuit design system. A CAD 1 is a tool for designing a circuit board, and it generates CAD data including a board shape, a pattern shape, and element information. A power supply noise analysis model generator 2 according to the present invention uses CAD data generated by the CAD 1, to generate a power supply noise analysis model which a circuit simulator 3 can use. The circuit simulator 3 simulates a circuit with the use of the power supply noise analysis model generated by the power supply noise analysis model generator 2.

Now, reference will be made to a circuit board as a target to be designed, modeled, and simulated according to the circuit design system. FIGS. 2A and 2B are views showing a configuration example of the circuit board which is a target to be modeled by the power supply noise analysis model generator in the present embodiment. To simplify the description, a board constituted by three layers is exemplified in this embodiment. FIG. 2A is a plan view showing each layer of the circuit board from upside. FIG. 2B is a cross-sectional view of the circuit board shown in FIG. 2A.

The circuit board shown in FIGS. 2A and 2B is constituted by one signal layer 101 and two power supply layers 102 and 103. The power supply layer 102 has a power supply island 106 of 3.3V and a power supply island 107 of 2.5V. The power supply layer 103 has a power supply island 108 of GND. Each of the power supply islands means a surface pattern and a line pattern of a power supply or GND. Elements a and b 104, 105 such as LSIs or the like are mounted on the signal layer 101. The element a 104 is connected to the power supply island 106 through a via 109, as well as to the power supply island 108 through a via 110. Also, the element b 105 is connected to the power supply island 108 through a via 111, as well as to the power supply island 107 through a via 112.

Electric fields and magnetic fields are generated from the power supply islands 106, 107 and 108 as shown in FIGS. 2A and 2B. Therefore, power supply noise is created in the space between any two power supply islands. The present invention uses two of the power supply islands respectively existing in different power supply layers, to generate a power supply noise analysis model which considers influences from the electric and magnetic fields.

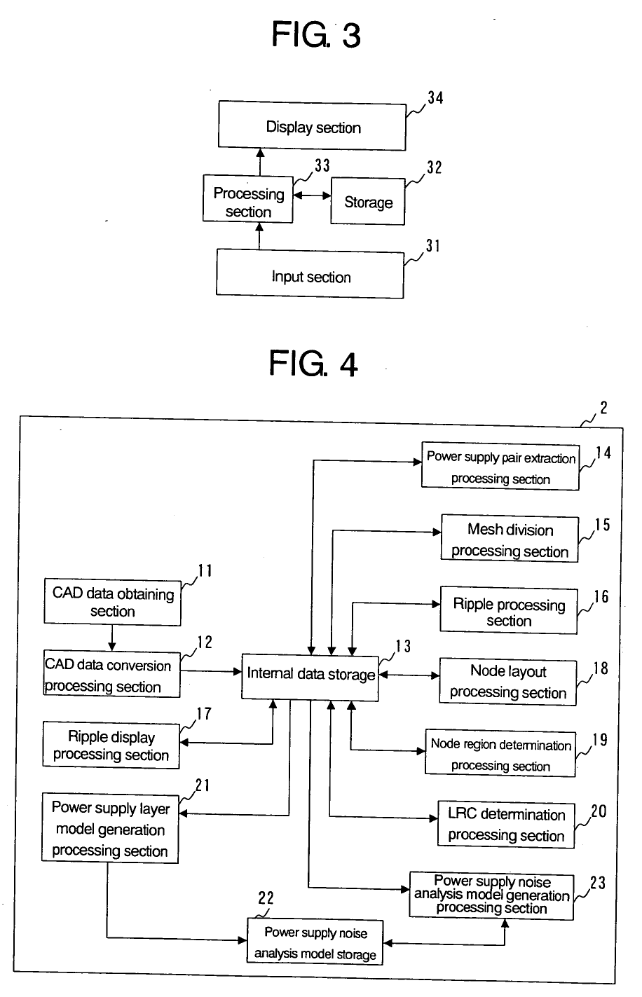

Next, a description will be made of the power supply noise analysis model generator 2. FIG. 3 is a block diagram showing an example of hardware configuration of the power supply noise analysis model generator in the present embodiment. As shown in FIG. 3, the hardware which realizes the power supply noise analysis model generator 2 is constituted by an input section 31 which receives inputs from a user, a storage 32 which stores data necessary to generate a power supply noise analysis model, a processing section 33 which processes data, and a display section 34 which displays power supply noise analysis results and the like.

Described next will be the structure of the power supply noise analysis model generator 2. FIG. 4 is a block diagram showing an example of software configuration of the power supply noise analysis model generator in the present embodiment. As shown in FIG. 4, the power supply noise analysis model generator 2 is constituted by a CAD data obtaining section 11, a CAD data conversion processing section 12, an internal data storage 13, a power supply pair extraction processing section 14, a mesh division processing section 15, and a ripple processing section 16, a ripple display processing section 17, a node layout processing section 18, a node region determination processing section 19, an LRC determination processing section 20, a power supply layer model generation processing section 21, a power supply noise analysis model storage section 22, and a power supply noise analysis model generation processing section 23.

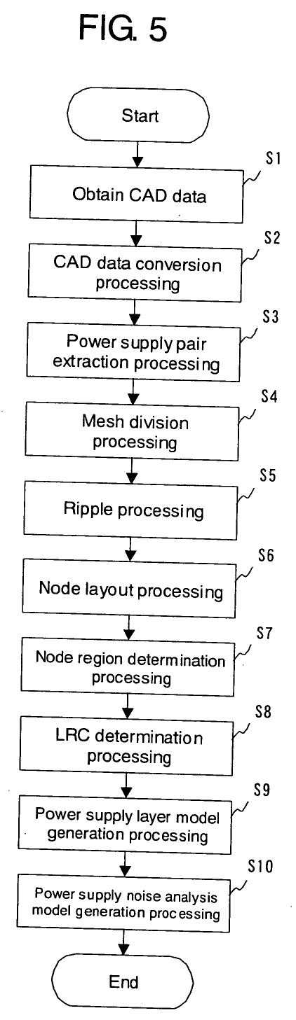

Hereinafter, the operation of the power supply noise analysis model generator 2 will be described along the flowchart shown in FIG. 5.

Described at first will be a processing S1. The CAD data obtaining section 11 obtains CAD data generated and stored in advance by CAD.

Now, a description will be made of a processing S2. The CAD data conversion processing section 12 converts CAD data into data suitable for power supply noise analysis. That is, the CAD data is converted into power supply island pattern data, lead pattern data, via pattern data, and elements data, deleting useless data from the CAD data and correcting values of the CAD data. Herein, the power supply island pattern data expresses pattern shapes of the power supply islands. In addition, lead pattern data expresses pattern shapes of lines leading from power supply pins of elements and GND pins to vias. The via pattern data expresses pattern shapes of lines connecting the power supply layers. The vias to be mentioned herein express those connected to the power supply or the patterns of GND. Every piece of data converted by the CAD data conversion processing section 12 is stored into the internal data storage 13.

Next, a description will be made of a processing S3. The power supply pair extraction processing section 14 extracts a power supply pair with the use of power supply island pattern data stored in the internal data storage 13.

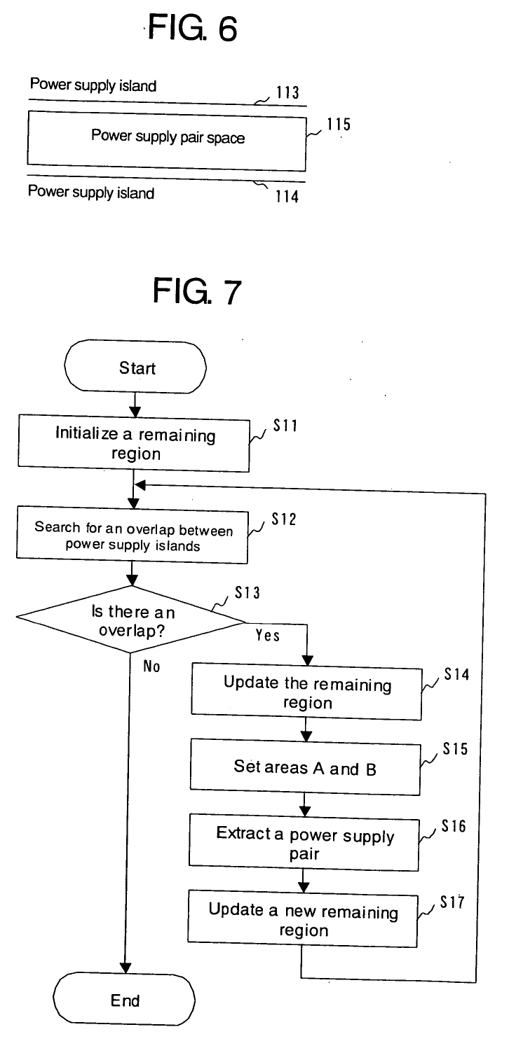

FIG. 6 is a cross-sectional view showing an example of a power supply pair. When two power supply islands existing in different power supply layers overlap each other like the power supply islands 113 and 114, the couple of power supply islands 113 and 114 is called a power supply pair. The space sandwiched between the power supply pair of power supply islands 113 and 114 is called a power supply pair space 115. In addition, the power supply island 113 is called the upper surface of the power supply pair, as well as the power supply island 114 the lower surface thereof.

Described next will be a power supply pair extraction processing. FIG. 7 is a flowchart showing the flow of the power supply pair extraction processing. At first, a remaining region are initialized to attain all power supply islands (S11). Next, an overlap of power supply islands on each other is searched for from the remaining regions (S12). If there is no overlap (No in S13), the flow ends.

If there is any overlap (Yes in S13), a part including the overlap in the remaining region is taken as a new remaining region (S14). Next, in this remaining region, the power supply island positioning in the uppermost layer is set as an area A, and the power supply island positioned in the second layer from the top is set as an area B (S15). Next, an overlapping part between the areas A and B is extracted as a power supply pair in which the overlapping part of the area A is extracted as the upper surface of the power supply pair, as well as the overlapping part of the area B the lower surface of the power supply pair. This power supply pair is stored as power supply pair data into the internal data storage 13 (S16). Next, the region defined by excluding the part of the power supply pair in the area A from the remaining region is taken as a new remaining region (S17), and the flow returns to the processing S12.

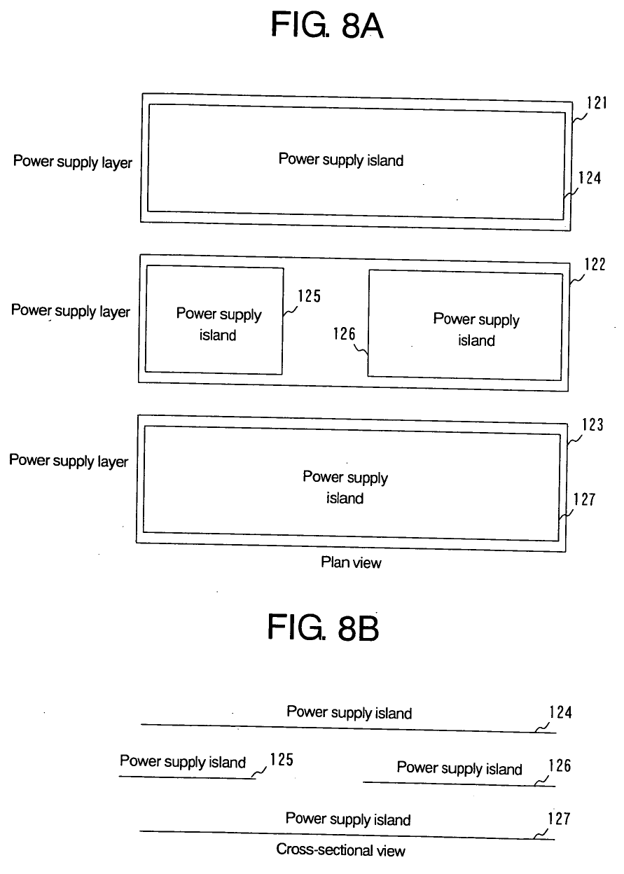

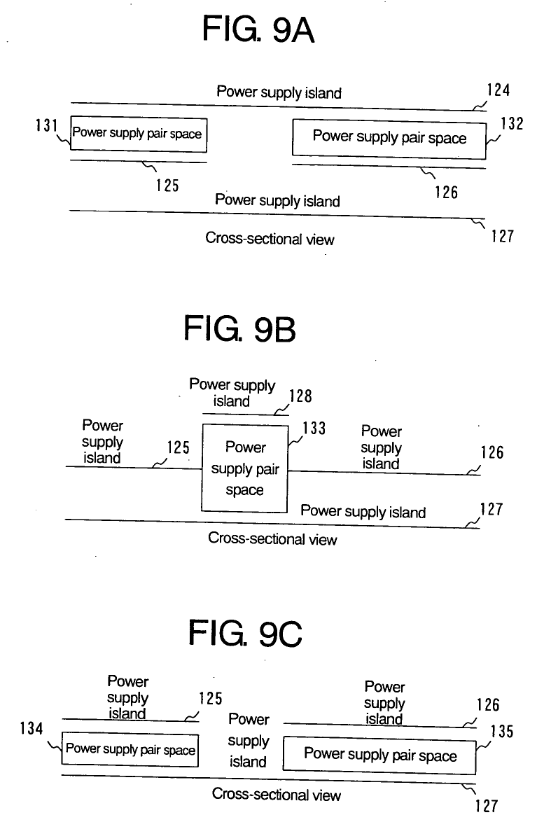

Next, a specific example of the power supply pair extraction processing will be described. At first, an example in which plural power supply islands exist in power supply layers will be described with reference to FIGS. 8A, 8B and 9A through 9C. FIG. 8A shows plan views of layers of a circuit board viewed from upside. FIG. 8B is a cross-sectional view of the circuit board shown in FIG. 8A. A power supply layer 121 has one power supply island 124. Another power supply layer 122 has two power supply islands 125 and 126. A further power supply layer 123 has one power supply island 127.

At first, the power supply islands 124, 125, 126 and 127 are taken as a remaining region. Then, any overlap among the power supply islands is searched for from the remaining region. Since overlaps exist among the power supply islands 124, 125, 126 and 127, the power supply islands 124, 125, 126 and 127 are taken as a new remaining region. Thereafter, the power supply island 124 is taken as an area A, and the power supply islands 125 and 126 are taken as an area B.

Subsequently, the part where the power supply island 124 and the power supply island 125 overlap each other is taken as a power supply pair space 131, so a power supply pair is thus extracted. Then, the part where the power supply island 124 and the power supply island 126 overlap each other is taken as a power supply pair space 132, and the power supply pair is extracted (FIG. 9A).

Thereafter, the region defined by excluding the part of the power supply pair in the area A from the remaining region is taken as a new remaining region, i.e., the power supply islands 128, 125, 126 and 127 are taken as a new remaining region. Subsequently, any overlap among the power supply islands each other is searched for from the remaining region. Since overlaps exist among the power supply islands 128, 125, 126 and 127, the power supply islands 128, 125, 126 and 127 are taken as a new remaining region. Then, the power supply island 128 is taken as an area A, and the power supply island 127 is taken as an area B.

Next, the part where the power supply islands 128 and 127 overlap each other is taken as a power supply pair space 133, so a power supply pair is thus extracted (FIG. 9B).

Then, the region defined by excluding the part of the power supply pair in the area A from the remaining region is taken as a new remaining region, i.e., the power supply islands 125, 126 and 127 are taken as a new remaining region. Subsequently, any overlap among the power supply islands is searched for from the remaining region. Since overlaps exist among the power supply islands 125, 126 and 127, the power supply islands 125, 126 and 127 are taken as a new remaining region. Next, the power supply island 125 and 126 are taken as an area A, and the power supply island 127 is taken as an area B.

Thereafter, the part where the power supply islands 125 and 127 overlap each other is taken as a power supply pair space 134, so a power supply pair is thus extracted. The part where the power supply islands 126 and 127 overlap each other is taken as a power supply pair space 135, and a power supply pair is thus extracted (FIG. 9C).

Next, the region defined by excluding the part of the power supply pair in the area A from the remaining region is taken as a new remaining region, i.e., the power supply island 127 is taken as a new remaining region. Subsequently, any overlap among the power supply islands is searched for from the remaining region. Since there is no overlap in the power supply island 127, the power supply pair extraction processing is terminated. Through the processing described above, five power supply pairs are extracted from the power supply layers 121, 122 and 123.

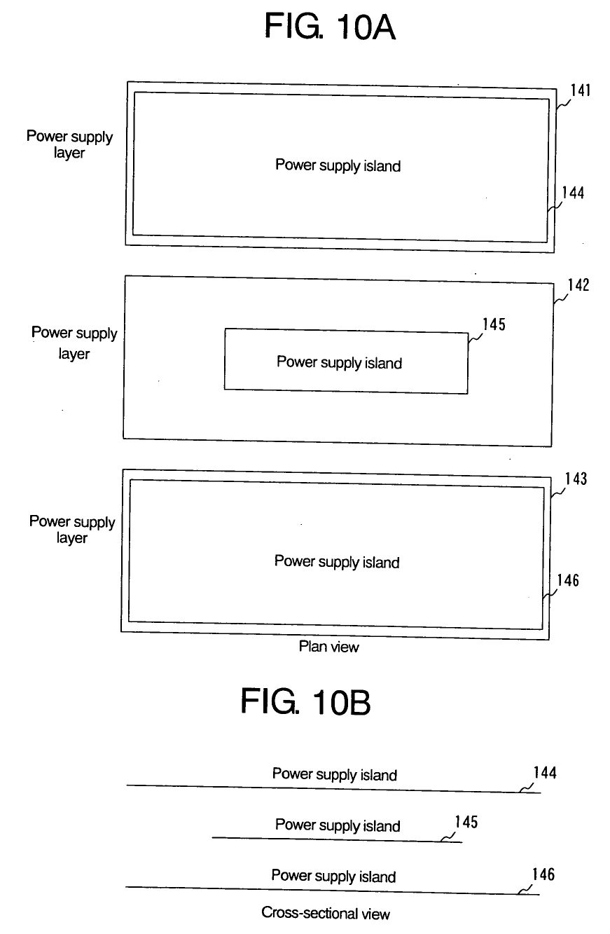

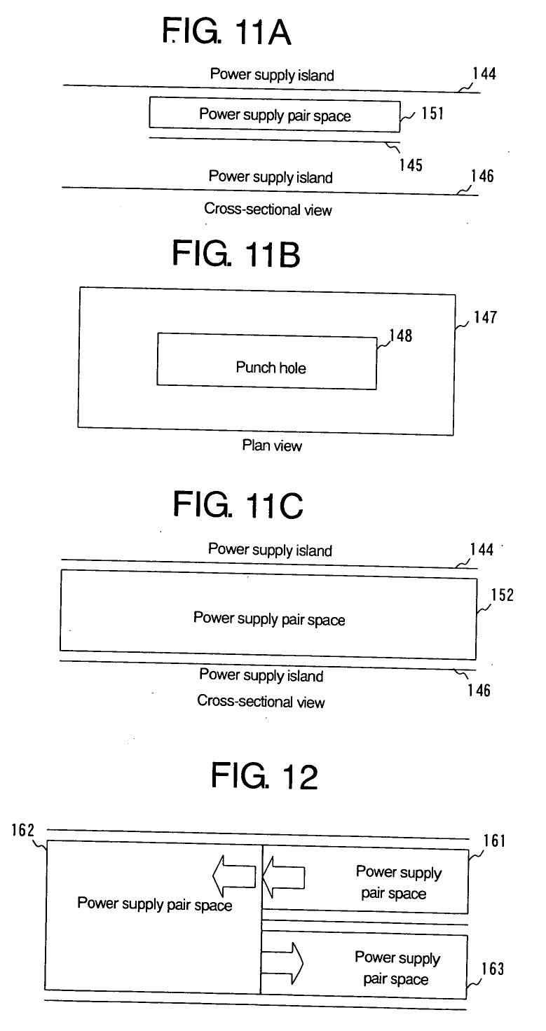

Then, an example in which power supply islands are contained in power supply layers will be described with reference to FIGS. 10 and 11. FIG. 10A shows plan views of layers of a circuit board viewed from upside. FIG. 10B is a cross-sectional view of the circuit board shown in FIG. 10A. The power supply layer 141 has a power supply island 144. The power supply layer 142 has a power supply island 145. The power supply layer 143 has a power supply island 146.

At first, the power supply islands 144, 145 and 146 are taken as a remaining region. Next, any overlap among power supply islands is searched for from the remaining region. Since the power supply islands 144, 145 and 146 overlap each other, these power supply islands 144, 145 and 146 are taken as a new remaining region. Next, the power supply island 144 is taken as an area A, as well as the power supply island 145 as an area B.

Next, the part where the power supply islands 144 and 145 overlap each other is taken as a power supply pair space 151, so a power supply pair is thus extracted (FIG. 11A).

Then, the region defined by excluding the part of the power supply pair in the area A from the remaining region is taken as a new remaining region, i.e., the power supply islands 147 and 146 are taken as a new remaining region. The power supply island 147 looks as shown in FIG. 11B in its plan view from the upside of the board. Herein, the part deleted from the power supply island 145 is taken as a punch hole 148. Subsequently, any overlap among the power supply islands is searched for from the remaining region. Since the power supply islands 147 and 146 overlap each other, the power supply islands 147 and 146 are taken as a new remaining region. Next, the power supply island 147 is taken as an area A, as well as the power supply island 146 as an area B.

At this time, if a punch hole exists in the power supply island 147, the part where the power supply islands 144 and 146 overlap each other before deletion from the power supply island 145 is taken as a power supply pair space 152, and a power supply pair is thus extracted (FIG. 11C). Further, the punch hole 148 is taken as a hole in the power supply pair space 152. The power supply pair space 152 and the punch hole 148 are combined to constitute a power supply pair having a punch hole.

Next, the region defined by excluding the part of the power supply pair in the area A from the remaining region is taken as a new remaining region, i.e., the power supply islands 145 and 146 are taken as a new remaining region. Extraction of the power supply pair of the power supply islands 145 and 146 is performed in the same manner as described with reference to FIGS. 9A through 9C. Through the processing described above, three power supply pairs are extracted from the power supply layers 141, 142 and 143.

Described next will be a power supply pair group. Electric and magnetic fields are generated mainly from power supply pair spaces each sandwiched between a pair of power supplies. However, electric and magnetic fields wrapping around the outside of each power supply pair space are also generated from the edge of each space. FIG. 12 is a cross-sectional view showing influences on adjacent power supply pair spaces from electromagnetic waves. As shown in FIG. 12, electric and magnetic fields generated from a power supply pair space 161 wrap around its own edge, thereby to influencing the power supply pair space 162 which contacts the power supply pair space 161. These electric and magnetic fields further influence the power supply pair space 163 contacting the power supply pair space 162. In consideration of the wrapping, power supply pairs which are influenced by electric and magnetic fields from each other are grouped to increase the accuracy of the power supply noise analysis, in the present embodiment.

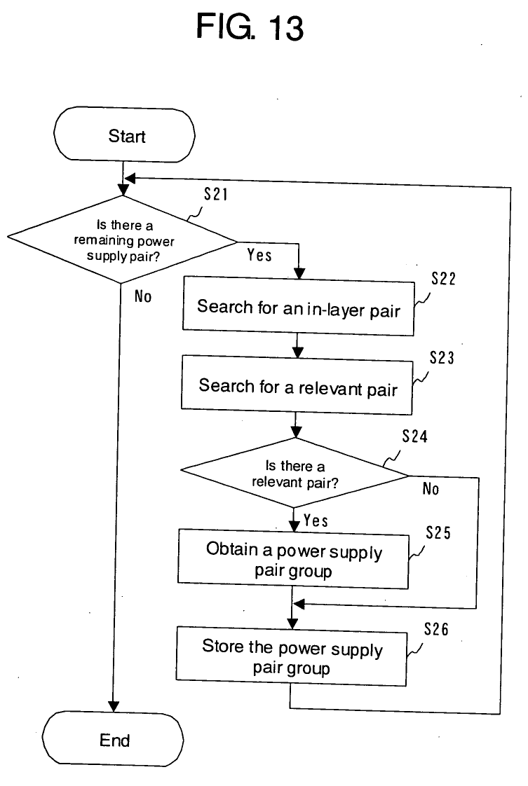

FIG. 13 is a flowchart showing the flow of a power supply pair group extraction processing. At first, if there is a pair of power supplies which are not yet grouped (Yes in S21), the power supply pair is taken as a key pair, and an in-layer pair corresponding to the key pair is searched for (S22). The in-layer pair means a power supply pair any part of which exists between the layer including the power supply pair upper surface of the key pair and the layer including the power supply pair lower surface thereof.

Next, a relevant pair to the key pair is searched for from the in-layer pair or pairs (S23). The relevant pair is a power supply pair having a power supply pair space which contacts or overlaps the power supply pair space of the key pair. The relevant pair is grouped with the key pair. If there is no relevant pair to the key pair (No in S24), only the key pair is taken as a member of the power supply pair group, and the flow proceeds to the processing S26.

Alternatively, if there is a relevant pair of the key pair (Yes in S24), the power supply pair group to which the relevant pair belongs is obtained (S25), and the key pair and the power supply pair group to which the relevant pair belongs are taken as new members of the power supply pair group. Next, the power supply pair thus taken as a target to be grouped is stored as one power supply pair group into the internal data storage 13 (S26), and the flow returns to the processing S21.

If all of the power supply pairs are stored as members of the power supply pair group (No in S21), the flow is terminated. According to the processing described above, the power supply pair extracted by the power supply pair extraction processing section 14 is stored as power supply pair data into the internal data storage 13.

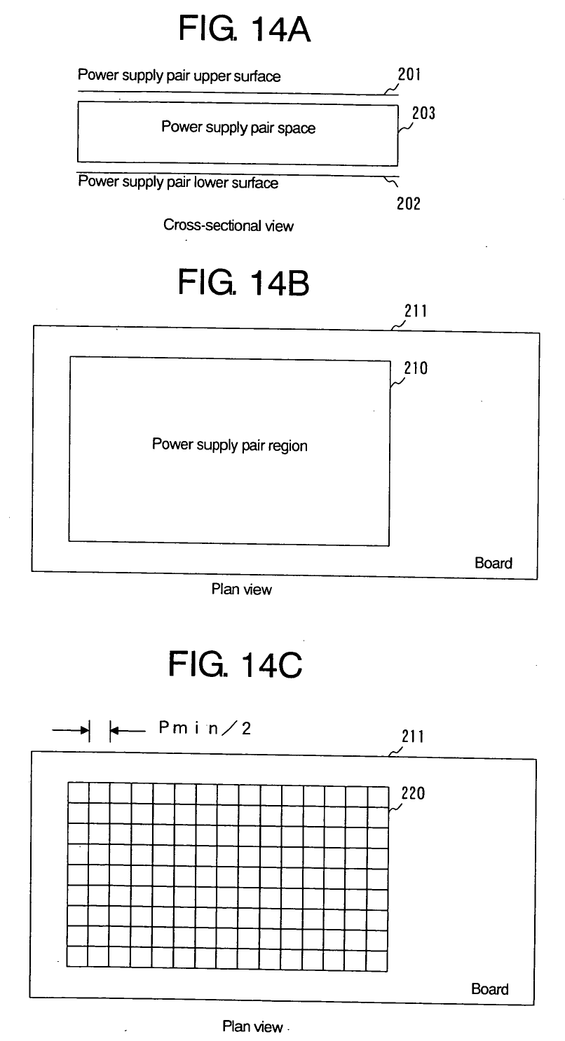

Described next will be a processing S4. At first, a mesh division processing section 15 calculates a power supply pair region from the power supply pair data stored in the internal data storage 13. FIGS. 14A through 14C show an example of a calculation result of a power supply pair region. FIG. 14A is a cross-sectional view showing a power supply pair space 203 sandwiched between a power supply pair upper surface 201 and a power supply pair lower surface 202. FIG. 14B is a plan view of the power supply pair region viewed from the upside of a board 211. As shown in FIG. 14B, the region occupied by the power supply pair space 203 in the plan view of the board 211 is taken as a power supply pair region 210.

The mesh division processing section 15 then obtains a time T which is a rising or falling time for every element, from element data stored in the internal data storage 13. The higher the operation frequency of the element, the smaller the time T. Subsequently, the smallest time T among the values of the time T for the respective elements is used to calculate the maximum operation frequency Fmax of the element having the highest frequency, by the following expression (1).

Fmax=1/(π×T) (1)

Next, Fmax is used to calculate the minimum analysis pitch Pmin which is the pitch between ripples of the electromagnetic wave radiated from the element having the highest operation frequency, by the following expression (2).

Pmin=c/(Fmax×εr\hat{ }(½))×0.1×0.6 (2)

In this expression, c is the velocity of light 2.9979 ellmm/s, and ε r is the dielectric coefficient of insulating material of the board. The ripple expresses a distribution of the electromagnetic wave radiated from the element, as a wave front per wavelength. The higher the operation frequency of the element radiating the electromagnetic wave, the shorter the interval between the ripples. Another characteristic is that, as the electromagnetic wave travels farther on the board, attenuation and waveform weakening appear more clearly, extending the distance between the rise and fall of the waveform, to increase the Pmin value.

Next, the mesh division processing section 15 divides the power supply pair region into meshes each of which is a square of Pmin/2 (edge length), and the meshes are taken as a mesh region. FIG. 14C is a plan view showing an example of a mesh region. In this case, the mesh region 220 is obtained by dividing the power supply pair region 210 shown in FIG. 14B into meshes. The mesh region 220 is stored into the internal data storage 13 in units of meshes as a mesh table in which each set of x and y coordinates on the board corresponds to an address on the table. Afterward, data calculated in units of meshes are stored at corresponding addresses on the mesh table.

Next, a processing S5 will be described. The ripple processing section 16 performs ripple processing by use of a mesh table and element data stored in the internal data storage 13. The ripple processing calculates ripples of the electromagnetic waves radiated from respective elements in power supply pair regions. Every ripple spreads from the outline of an element. Where the outline of the element is supposed to be a ripple at a ripple level 0, a ripple spread next is a ripple at a ripple level 1, and a ripple spread n times is a ripple at a ripple level n. The distance from the ripple at the ripple level 0 to the ripple at the ripple level 1 is the ripple pitch at the ripple level 0. The distance from the ripple at the ripple level n to the ripple at the ripple level n+1 is the ripple pitch at the ripple level n.

Described now will be a case that elements a and b are mounted on an observed mesh region. The ripple pitch Pmin_a(0) at the ripple level 0 with respect to ripples of the element a, is the value of Pmin calculated from the expressions (1) and (2) with the use of T which the element a has. Similarly, the ripple pitch Pmin_b(0) at the ripple level 0 with respect to ripples of the element b, is the value of Pmin calculated from the expressions (1) and (2) with the use of T which the element b has. Where n is 1 or more, the ripple pitch Pmin_a(n) at the ripple level n with respect to ripples of the element a is updated from the following expression (3) with the use of the ripple pitch Pmin_a(n−1) at the ripple level n−1.

Pmin_{—}a(n)=[Pmin_{—}a(n−1)\hat{ }2+Kd×{S(n)\hat{ }(½)−S(n−1)\hat{ }(½)}]\hat{ }(½) (3)

In this expression, Kd is a compensation coefficient, and S(n) is the area of meshes existing inside the ripple at the ripple level n among the mesh region. Similarly, the ripple pitch Pmin_b(n) at the ripple level n with respect to ripples of the element b is obtained by replacing the symbol letter a with b in the expression (3).

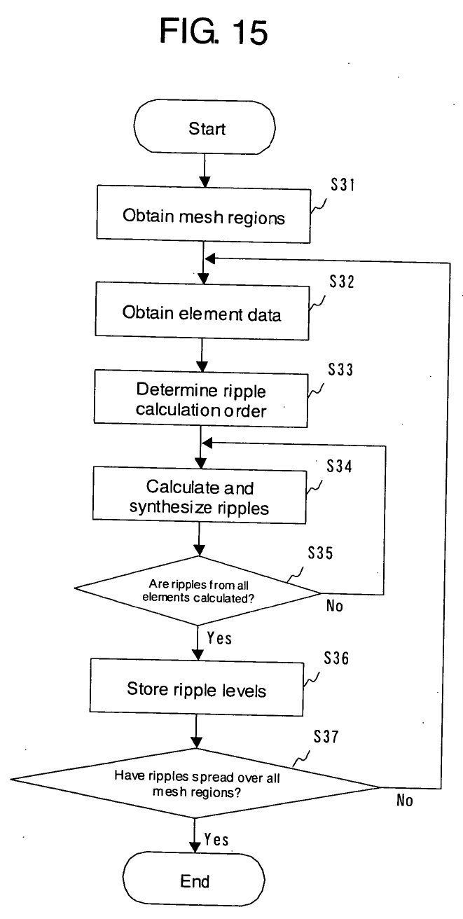

Next, the flow of the ripple processing will be described. FIG. 15 is a flowchart showing the flow of the ripple processing. The ripple processing section 16 observes all mesh regions which belong to one power supply pair group and obtains in the mesh table stored in the internal data storage 13. The ripple processing section 16 obtains the observed mesh regions (S31), and obtains element data of elements mounted within the mesh regions (S32). Next, the ripple pitches are calculated and compared with each other, to determine the ripple calculation order in which the elements are arranged orderly from one having the smallest ripple pitch (S33).

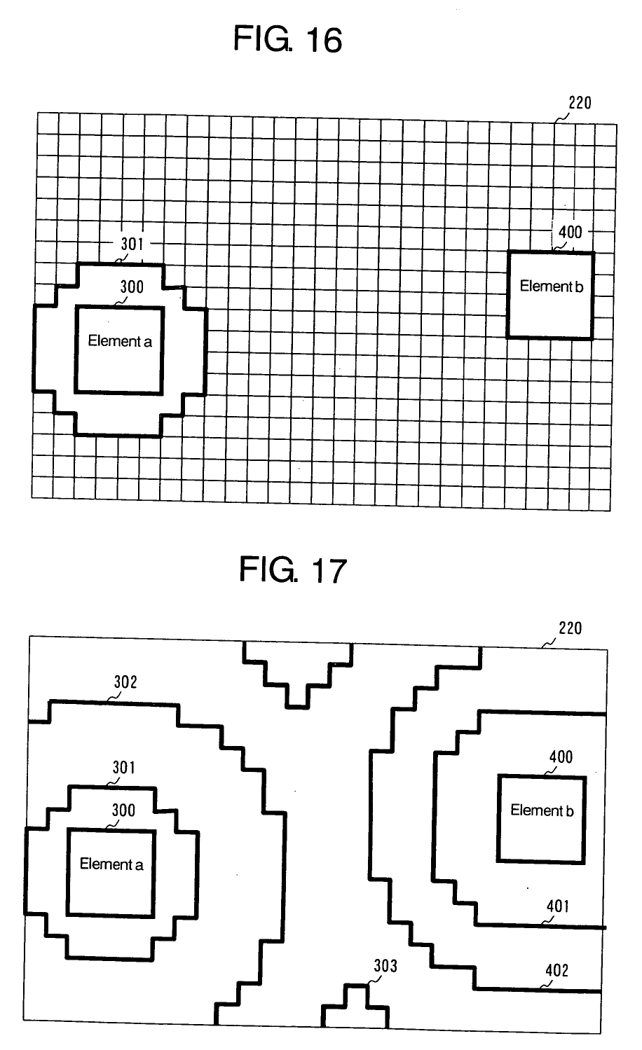

Subsequently, in the order from the element having the smallest ripple pitch, ripples are calculated and synthesized (S34). The ripple at the ripple level n+1 has a shape spread vertically from the ripple at the ripple level n by the ripple pitch at the ripple level n. FIG. 16 is a plan view showing an example of a calculation result of the first ripple. In this case, an element a 300 and an element b 400 are mounted in a mesh region 220 and Pmin_a(0) is smaller than Pmin_b(0). This figure illustrates a result of calculating a ripple 301 at the ripple level 1 which is radiated first from the element a 300.

As has already been shown in FIG. 12, an electromagnetic wave radiated from a power supply pair space of a power supply pair group propagates to another power supply pair space which belongs to the same power supply pair group. Therefore, after a ripple of a mesh region reaches to a boundary to another mesh region, the ripple spreads from the boundary into the another mesh region.

If a ripple at a ripple level n from an element overlaps a ripple also at the ripple level n from another element, an outline defined by synthesizing the outlines of these ripples is taken as the ripple at the ripple level n. FIG. 17 is a plan view illustrating a state in which the ripple processing has further proceeded, and shows an example of a calculation result of ripples up to the ripple level 3. A ripple 301 at a ripple level 1 radiated from the element a 300, a ripple 302 at a ripple level 2, a ripple 401 at a ripple level 1 radiated from the element b 400 and a ripple 402 at a ripple level 2 are shown. Further, a ripple at a ripple level 3 radiated from the element a 300 overlaps a ripple also at the ripple level 3 radiated from the element b 400. These ripples are synthesized and represented by a ripple 303 at the ripple level 3.

Next, whether all the elements in observed mesh regions have been calculated or not is determined (S35). If there is an element left uncalculated (No in S35), the flow returns to the step S34. After ripples are calculated with respect to all the elements, the ripple level n is stored at corresponding addresses in the mesh table in the internal data storage 13, with respect to meshes existing between the ripple at the ripple level n−1 and the ripple at the ripple level n.

Then, whether or not ripples have spread over all the observed mesh regions is determined (S37). If there is a region to which ripples have not yet spread (No in S37), the flow returns to S32. Otherwise, ripples have already spread over all the observed mesh regions (Yes in S37), the flow is terminated. The ripple levels extracted according to the above processing by the ripple processing section 16 are stored into the internal data storage 13 in units of meshes.

A ripple display processing will now be described. The ripple display processing section 17 performs the ripple display processing with the use of the ripple levels on the mesh table stored in the internal data storage 13. The user can know distributions of electromagnetic waves through the ripple display processing, and can specify easily where countermeasures should be provided against noise. In case where ripples are displayed as figures on the display section 34, there has been a problem that a very long time is needed before the ripples are displayed if the ripple levels stored in units of meshes are drown as filled figures. To solve this problem, an efficient optimal order need to be prepared. In the ripple display processing according to the present embodiment, coordinates of outlines of ripples are obtained, and data are prepared in a manner of one order per ripple. The orders of the all ripples are drawn together to shorten the drawing time.

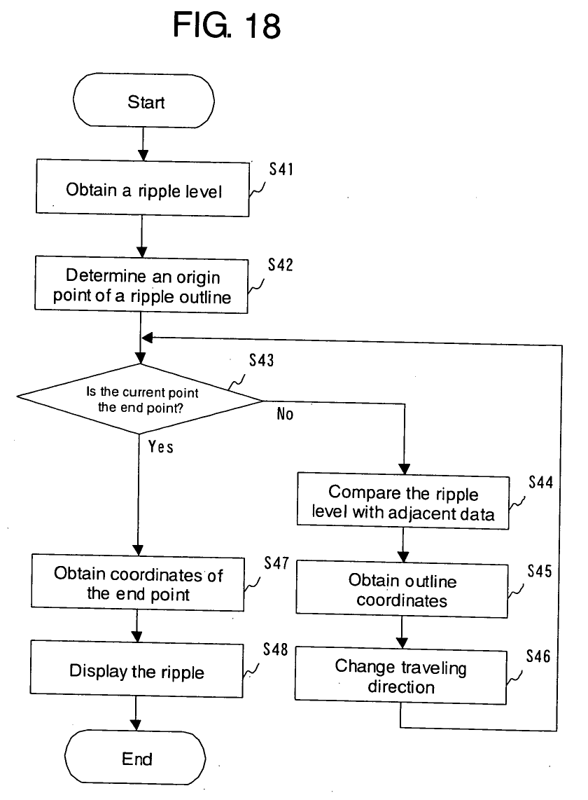

FIG. 18 is a flowchart showing the flow of the ripple display processing. At first, a ripple level is obtained from the internal data storage 13 (S41). Next, the origin point of the ripple outline is determined (S42). The origin point is determined in accordance with the direction in which the coordinates of the ripple outline are searched for. If the coordinates are searched for in the rightward direction, the coordinates of the left lower corner of the mesh is taken as the origin point. Alternatively, if the coordinates are searched for in the upward direction, the coordinates of the right lower corner of the mesh is taken as the origin point. If the coordinates are searched for in the leftward direction, the coordinates of the right upper corner of the mesh is taken as the origin point. If the coordinates are searched for in the downward direction, the coordinates of the left upper corner of the mesh is taken as the origin point. The following is a description in the case of searching for the coordinates of the ripple outline in the rightward direction.

The search for the coordinates of the ripple outline starts from the origin point and continues until the search reaches again the origin point. If a current point is not the origin point (No in S43), the ripple level at the current point and the ripple level at adjacent data are compared with each other, to inspect or check whether these levels are equal (S44). In accordance with the result of the inspection, the outline coordinates are obtained (S45), and the traveling direction is determined (S46). The flow then returns to the processing S43. With respect to the meshes whose outline coordinates have been obtained, outline or contour processing flags are stored at corresponding addresses on the mesh table in the internal data storage 13.

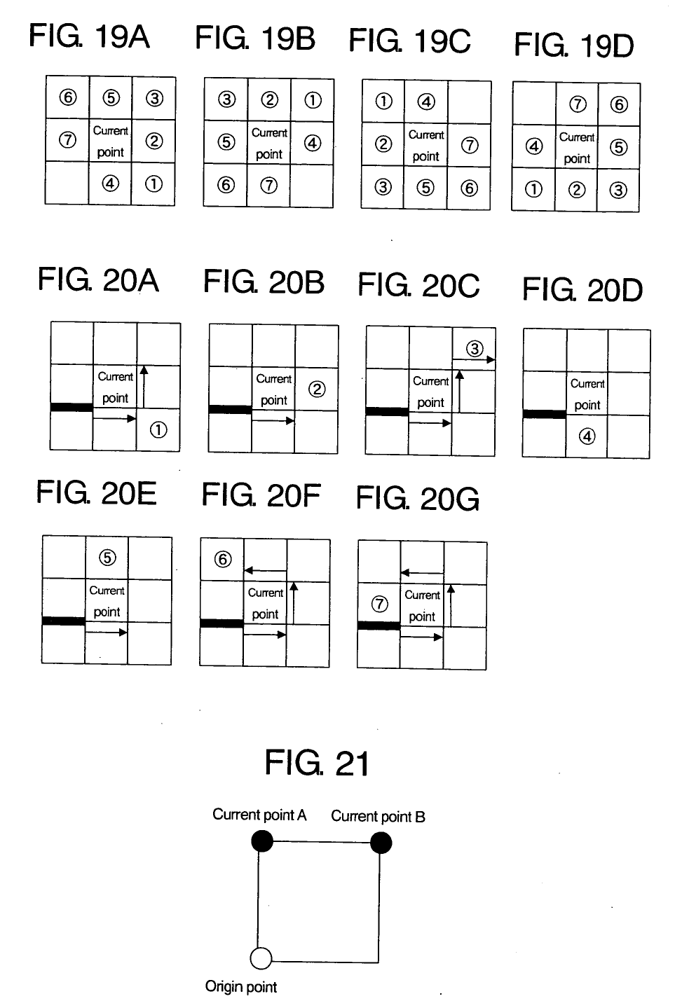

FIGS. 19A through 19D show views indicating the inspection orders with respect to the respective search directions. In FIGS. 19A through 19D, \mathring{1} to \mathring{7} denote the degrees in each order. FIGS. 19A through 19D show the inspection orders where the search is carried out in the rightward, upward, leftward, and downward directions, respectively. In this case, the ripple outline is searched for in the rightward direction, so that the ripple level at adjacent data is checked in the order from the degree \mathring{1} in accordance with FIG. 19A.

FIGS. 20A through 20G show views indicating positions of outline coordinates. In FIGS. 20A through 20G, the fat lines indicate lines connecting the outline coordinates which have already been obtained. The top of each arrow indicates outline coordinates to be obtained newly.

If the adjacent data item \mathring{1} is at an equal ripple level, the left upper coordinates of the adjacent data item \mathring{1} are obtained as the outline coordinates, and the traveling direction is changed to the downward direction (FIG. 20A).

If the adjacent data item \mathring{2} s at an equal ripple level, the left lower coordinates of the adjacent data item \mathring{2} are obtained as the outline coordinates, and the traveling direction is not changed (FIG. 20B).

If the adjacent data item \mathring{3} is at an equal ripple level, the right lower coordinates of the current point are obtained as the outline coordinates, and then, the left lower coordinates and the right lower coordinates of the adjacent data item \mathring{3} are obtained as the outline coordinates. The traveling direction is changed to the upward direction (FIG. 20C).

If the adjacent data item \mathring{4} is at an equal ripple level, the outline coordinates are not obtained, and the traveling direction is changed to the downward direction (FIG. 20D).

If the adjacent data item \mathring{5} is at an equal ripple level, the right lower coordinates of the current point are obtained as the outline coordinates, and then, the right lower coordinates of the adjacent data item \mathring{5} are obtained as the outline coordinates. The traveling direction is changed to the upward direction (FIG. 20E).

If the adjacent data item \mathring{6} is at an equal ripple level, the right lower coordinates and the right upper coordinates of the current point are obtained as the outline coordinates, and then, the right lower coordinates of the adjacent data item \mathring{6} are obtained as the outline coordinates. The traveling direction is changed to the upward direction (FIG. 20F).

If the adjacent data item \mathring{7} is at an equal ripple level, the right lower coordinates and the right upper coordinates of the current point are obtained as the outline coordinates, and then, the right upper coordinates of the adjacent data item \mathring{7} are obtained as the outline coordinates. The traveling direction is changed to the leftward direction (FIG. 20G).

The above description has been made to the case of searching for the ripple outline in the rightward direction. In the cases of searching in the upward, leftward, and downward directions, the method described above may be modified with the search directions shifted by 90 degrees from each other.

If the current point is the end point (Yes in S43), the coordinates of the end point are obtained (S47). Since the current point does not agree with the origin point, an end point processing as follows is carried out if the current point comes close the origin point again. FIG. 21 shows a relationship between the current point and the origin point. When the current point is at the point A relative to the origin point, (X coordinate of the origin point, Y coordinate of the origin point) are added as coordinates of the ripple outline, to connect the origin point to the current point A. Alternatively, when the current point is at the point B relative to the origin point, (X coordinate of the origin point, Y coordinate of the current point) are added as coordinates of the ripple outline, and further, (X coordinate of the origin point, Y coordinate of the origin point) are added as coordinates of the ripple outline, to connect the origin point to the current point B.

After the coordinates of the end point are obtained, the ripple is displayed according to the coordinates which generates the ripple outline (S48), and the flow is terminated. The above processing is performed on all the ripples, and thus, the ripple display processing section 17 displays the ripples on the display section 34.

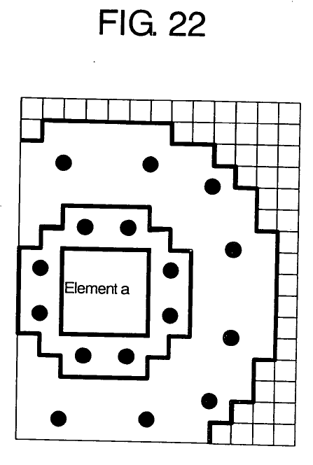

Described next will be a processing S6. A node layout processing section 18 uses the ripple levels on the mesh table stored in the internal data storage 13, to position nodes which are elements of power supply noise analysis models. FIG. 22 is a plan view showing an example of a mesh region where nodes are provided. The ripples shown in FIG. 22 are parts of the ripples obtained in FIG. 17. The nodes are positioned at intervals of a ripple pitch, in the region between a ripple at a ripple level n and a ripple at a ripple level n+1. For example, in the region between the ripple at the ripple level n and the ripple at the ripple level n+1 from a component a, the nodes are positioned at intervals of Pmin_a(n), and in the region between a ripple at the ripple level n and a ripple at a ripple level n+1 from a component b, the nodes are positioned at intervals of Pmin_b(n). With respect to meshes in which nodes are provided, node flags are stored at corresponding addresses on the mesh table in the internal data storage 13.

Next, a processing S7 will be described. A node region determination processing section 19 determines a regions surrounding each node with the use of the node flag on the mesh table stored in the internal data storage 13.

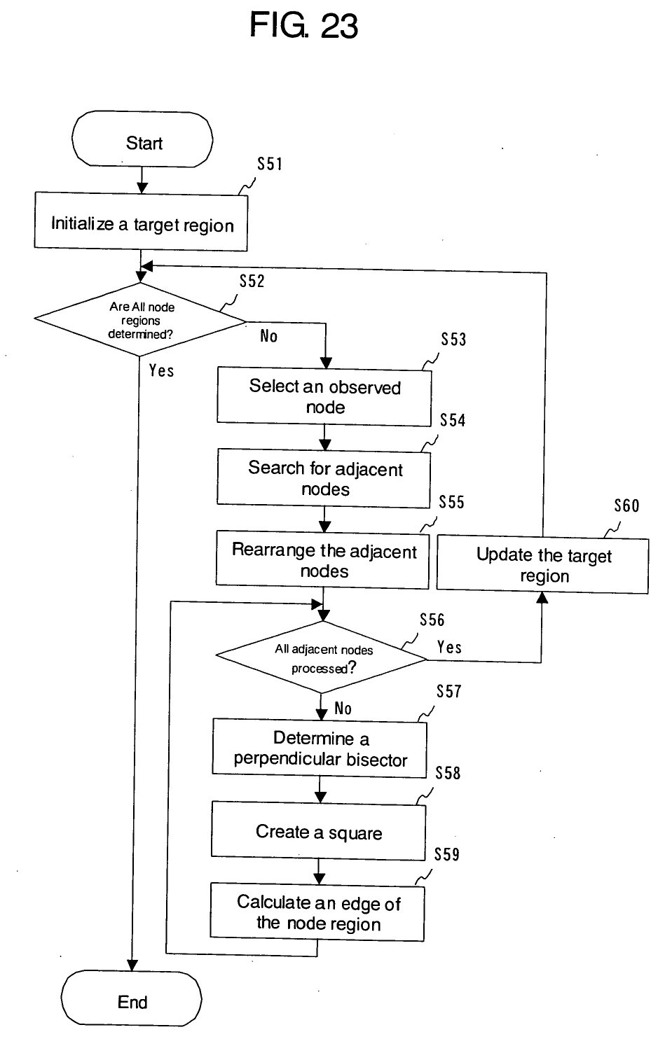

Described next will be the flow of the node region determination processing. FIG. 23 is a flowchart showing the flow of the node region determination processing. At first, a target region is initialized (S51). The target region means a power supply pair region as a target from which node regions are extracted from now on, and the first target region is the entire power supply pair region. Next, whether node regions have been determined with respect to all nodes is determined (S52). If node regions of all nodes have been determined (Yes in S52), the flow ends. Alternatively, if there is any node whose region is not yet determined (No in S52), a node whose node region should be determined is selected (S53). In this selection, nodes are selected in the order from the closest one to the coordinates of the origin point of the board. Any selected node is referred to as an observed node.

Next, an adjacent node to the observed node is searched for (S54). In this stage, a circle having a radius r is drawn about the observed node as the center of the circle. For every search area having a sector-like shape of a predetermined angle in the circle, nodes existing in the search area is searched for. The radius r is the maximum edge length of a rectangular region surrounding the target region, and the predetermined angle is 30 degrees, for example.

FIG. 24 is a view showing an example of the rectangular region surrounding the target region. When a target region 501 is surrounded by a rectangular region 502 as shown in FIG. 24, the maximum edge length of the rectangular region is the radius r of the circle.

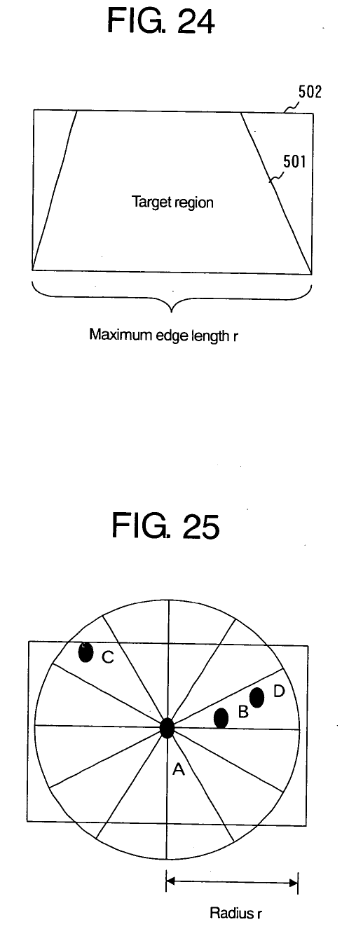

FIG. 25 is a view showing an example of search areas for adjacent nodes. Among nodes existing in each search area having an angle of 30 degrees, the closest node to the observed node is taken as the adjacent node. By performing the search from nine search areas, all the adjacent nodes existing in the circle can be searched for. In FIG. 25, A denotes the observed node. Although the search area including a node B also includes a node D, the closest node to the observed node is the node B. Therefore, the obtained adjacent nodes are the nodes B and C.

Next, the adjacent node thus searched for are rearranged in the order from the node closest to the observed node (S55). Thereafter, a processing for obtaining the edge of the node region of each observed node is performed in the rearranged order. The following description will be made to the case where two adjacent nodes B and C exist with respect to the observed node A.

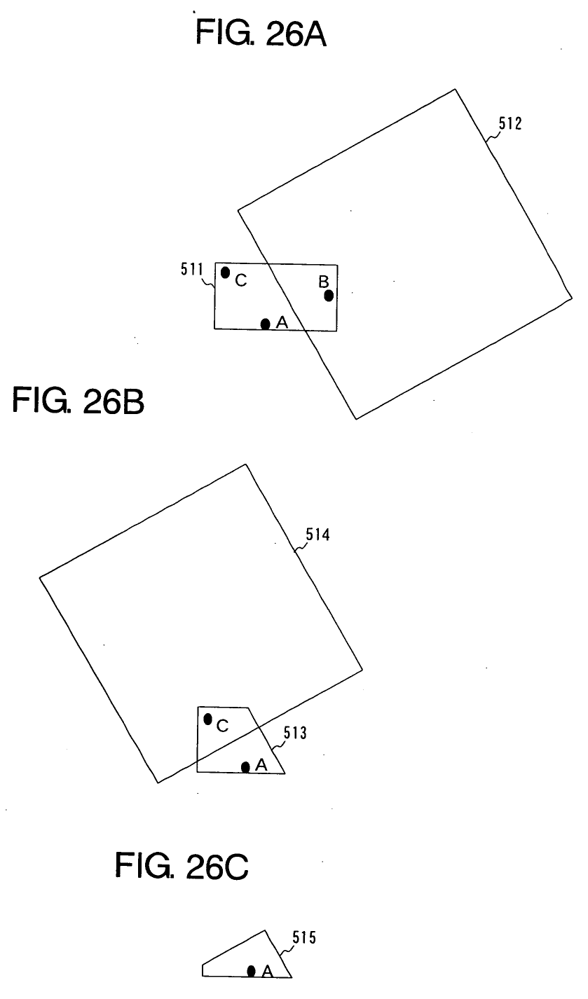

The node region determination processing for the observed node will now be explained with reference to a specific example. FIGS. 26A through 26C show specific examples of the node region determination processing for the observed node. As shown in FIG. 26A, the processing is performed firstly on the adjacent node B which is the closest to the observed node. In a target region 511, a perpendicular bisector is drawn between the observed node A and the adjacent node B (S57). The perpendicular bisector has a length of 2 r. Then, a square 512 having the perpendicular bisector as an edge is created (S58). At this time, the square 512 is created in such a direction (i.e., side) in which the square includes the adjacent node B and excludes the observed node A.

Next, the part overlapping the square 512 is removed from the target region 511, to calculate the edges of the node region (S59). As shown in FIG. 26B, the square 512 is removed from the target region 511, resulting in creation of a new target region 513.

The other adjacent node C which is not yet processed (No in S56), the processings S57 to S59 are also performed on the adjacent node C. As shown in FIG. 26B, a square 514 is created so as to have the perpendicular bisector between the observed node A and the adjacent node C as an edge and include the adjacent node C. As shown in FIG. 26C, the square 514 is removed from the target region 513, resulting in creation of a new target region 515. The final target region 515 is taken as the node region of the observed node A. As has been described above, the processings S57 to S59 are performed on all the adjacent nodes to the observed node, to determine one node region for the one observed node.

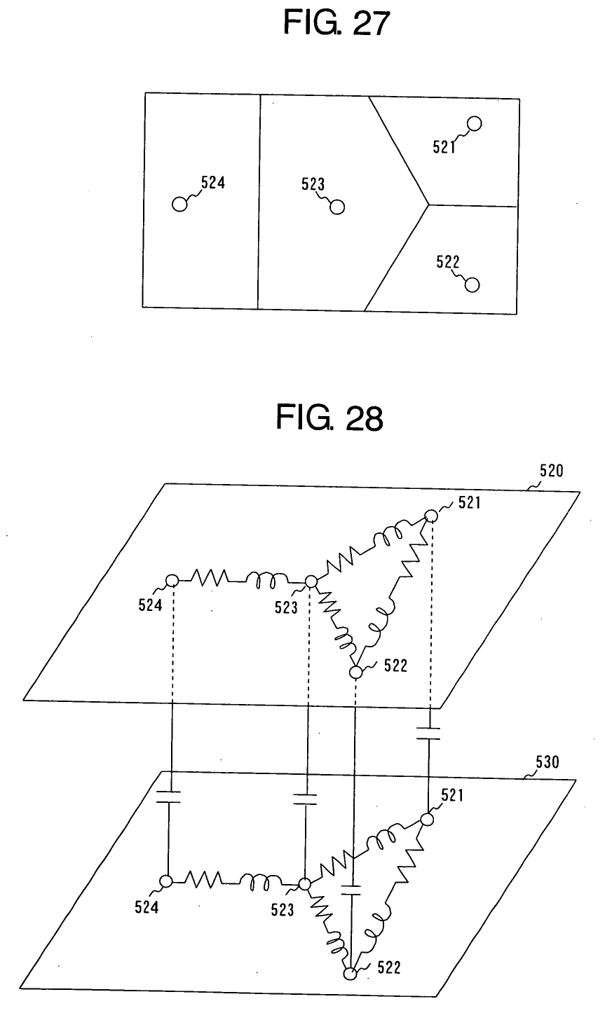

If the processings S57 to S59 are completed with respect to all the adjacent nodes (Yes in S56), the target region is updated by removing the node region of the observed node from the power supply pair region (S60), and the flow returns to the processing S52. FIG. 27 shows an example of node regions assigned to a power supply pair region. As shown in FIG. 27, the node regions 521, 522, 523 and 524 are separate from each other by perpendicular bisectors between every two adjacent nodes.

The node regions obtained by the node region determination processing section through the processing described above are stored as node identifiers on the mesh table in the internal data storage. For example, if a power supply pair region has three nodes, node identifiers 0 to 2 for identifying node regions are prepared and given to the meshes having the same node regions, respectively.

Next, described will be a processing S8. An LRC determination processing section 20 calculates values of L (Reactance), R (Resistance), and C (Interlayer Capacitance) connected between nodes with the use of the node flags, node identifiers, and power supply pair space data on the mesh table stored in the internal data storage 13.

The LRC determination processing section 20 uses the node flags to calculate distances between nodes, uses the node identifiers to calculate node region areas, and calculates power-supply interlayer distances from the power supply pair space data. The power-supply interlayer distance is the distance between a pair of power supplies. Then, the LRC determination processing section 20 determines L and R in correspondence with the distances between nodes, and also determines C with the use of the node region areas and the power-supply interlayer distances. The values of L, R, and C obtained by the LRC determination processing section 20 through these processings are stored as inter-node LRC data into the internal data storage 13.

Next, a processing S9 will be described. A power supply layer model generation processing section 21 generates a power supply layer model with the use of the node flags and inter-node LRC data on the mesh table stored in the internal data storage 13.

The power supply layer model generation processing section 21 connects nodes via LRC for every power supply pair, to generate a power supply layer model for every power supply pair. FIG. 28 shows an example of the power supply layer model. The power supply layer model in FIG. 28 is modeled by L, R, and C with the use of the node regions assigned to the power supply pair region shown in FIG. 27. L and R are provided between the nodes on a power supply pair upper surface 520 and also provided on a power supply pair lower surface 530. C is provided between each couple of nodes provided at equal positions on the power supply pair upper surface 520 and the power supply pair lower surface 530. The power supply layer model obtained through the processing described above is stored into the power supply noise analysis model storage 22.

A processing S10 will be described next. A power supply noise analysis model generation processing section 23 uses the lead pattern data and via pattern data stored in the internal data storage 13 and the power supply layer model stored in the power supply noise analysis model storage, to generate a power supply noise analysis model. More specifically, the via pattern data, the power supply layer model, and the lead pattern data are connected to each other to generate a power supply noise analysis model. The power supply noise analysis model obtained by this processing is stored into the power supply noise analysis model storage 22. A circuit simulator 3 performs a circuit simulation with the use of the power supply noise analysis model stored in the power supply noise analysis model storage 22, to analyze power supply noise.

In the foregoing discussion, the present embodiment has been described with respect to the generation of a power supply noise analysis model. However, the power supply noise analysis model generation processing section 23 may further obtain element data from the internal data storage 13, and may connect the element data to the above-described power supply noise analysis model, to generate a total circuit model. All the circuit models may be stored into the power supply noise analysis model storage 22. In this case, the total circuit can be simulated with power supply noise analysis taken into consideration.

As has been specifically described above, according to the present invention, a power supply noise analysis model is generated based on power supply pairs each constituted by two power supply islands existing in different power supply layers while taking the influences from electric and magnetic fields into consideration. As a result, power supply noise analysis can be performed with high accuracy, simulating closely the operation of an actual circuit board before manufacturing a circuit board. In addition, power supply layer models necessary for the power supply noise analysis can be created at a high speed.

While the invention has been described in terms of preferred embodiments, those skilled in the art will recognize that the invention can be practiced with modifications within the spirit and scope of the appended claims.

What is claimed is:

1. A power supply noise analysis model generator adapted to model power supply layers in a circuit board, said generator comprising:
a CAD data obtaining section that obtains CAD data including information concerning a board shape, pattern shapes, and elements;
a CAD data conversion processing section that converts said CAD data into power supply island pattern data, element data, lead pattern data, and via pattern data;
a power supply pair extraction processing section that extracts, if two power supply islands existing in two different power supply layers, respectively, overlap each other, said two power supply islands as a power supply pair;
a node layout processing section that positions plural nodes on a power supply pair region which is occupied by each power supply pair on a plane of said circuit board;
a node region determination processing section that determines node regions surrounding said nodes, respectively;
an impedance parameter determination processing section that determines impedance parameters expressing relationships between said nodes, respectively;
a power supply layer model generation processing section that connects said nodes to each other using said impedance parameters, to generate a power supply layer model; and
a power supply noise analysis model generation processing section that connects said power supply layer model, said lead pattern data and said via pattern data to one another to generate a power supply noise analysis model.

2. The power supply noise analysis model generator according to claim 1, wherein said impedance parameters are a reactance L, a resistance R, and an interlayer capacitance C.

3. The power supply noise analysis model generator according to claim 1, wherein if a power supply pair space sandwiched between power supplies of an observed power supply pair is contacted or overlapped by another power supply pair space of any other power supply pair, said power supply pair extraction processing section makes said observed power supply pair and said other power supply pair into a group.

4. The power supply noise analysis model generator according to claim 1, further comprising a ripple processing section that positions, on said power supply pair region, ripples which are wave fronts of electromagnetic waves radiated into said power supply pair region from said elements, wherein said node layout processing section positions said nodes, based on pitches of said ripples.

5. The power supply noise analysis model generator according to claim 4, wherein said ripple processing section uses rising or failing times of those of said elements which are mounted on said power supply pair region, maximum operating frequencies of those elements, and areas of said ripples, to calculate intervals between said ripples.

6. The power supply noise analysis model generator according to claim 4, wherein said ripple processing section spreads said ripples into power supply pair regions of power supply pairs which belong to a group.

7. The power supply noise analysis model generator according to claim 4, further comprising a ripple display processing section that searches for outline coordinates of said ripples, and displays said ripples with the use of said outline coordinates.

8. The power supply noise analysis model generator according to claim 1, further comprising a mesh division processing section that divides said power supply pair region with the use of meshes based on a wavelength of one of said elements mounted that has the highest operating frequency.

9. The power supply noise analysis model generator according to claim 8, further comprising an internal data storage which stores information for every of said meshes into a table on which coordinates on said circuit board correspond to addresses.

10. The power supply noise analysis model generator according to claim 9, wherein the information for every of said meshes includes at least one of a ripple level which indicates the number of ripples from an element to a corresponding mesh, the presence or absence of a node in said corresponding mesh, and a node region identifier expressing a node region to which said corresponding mesh belongs.

11. The power supply noise analysis model generator according to claim 1, wherein, taking a most adjacent node as the node closest to an observed node within a sector having a predetermined radius about said observed node as the center of said sector, said node region determination processing section searches for adjacent nodes by rotating said sector about said observed node.

12. The power supply noise analysis model generator according to claim 11, wherein said node region determination processing section removes a square from said power supply pair region thereby to determine an edge of the node region of said observed node with respect to said most adjacent node, said square having as an edge a perpendicular bisector of a predetermined length between said observed node and said most adjacent node and containing said most adjacent node, so that edges of said node region of said observed node are sequentially determined with respect to all the adjacent nodes, respectively, in the order of increasing distance from said most adjacent node, finally to determine the node region of said observed node.

13. The power supply noise analysis model generator according to claim 1, wherein said impedance parameter determination processing section determines a reactance L and a resistance R based on distances between said nodes, and determines an interlayer capacitance C with the use of the areas of said node regions and a distance or distances between power supply layers, and said power supply layer model generation processing section arranges said reactance L and said resistance R between nodes on an upper surface of each power supply pair and between nodes on a lower surface of each power supply pair, and arranges each interlayer capacitance C between such a couple of nodes that are arranged at equal positions respectively on the upper and lower surfaces of said power supply pair.

14. The power supply noise analysis model generator according to claim 1, further comprising a power supply noise analysis model storage that stores said power supply noise analysis model.

15. The power supply noise analysis model generator according to claim 1, wherein said power supply noise analysis model generation processing section further generates a total circuit model in which said power supply noise analysis model is connected to said element data, and stores said total circuit model into said power supply noise analysis model storage.

16. A power supply noise analysis model generator which models a power supply layer in a circuit board, said generator comprising:
a power supply pair extraction processing section that extracts, as a power supply pair, different two power supply layers overlapping each other in a layering direction from data indicative of said circuit board; and
a power supply noise analysis model generation processing section that uses said power supply pair extracted to generate a power supply noise analysis model.

17. A power supply noise analysis model generation method of modeling power supply layers in a circuit board, said method comprising:
a step of obtaining CAD data including information concerning a board shape, pattern shapes, and elements;
a step of converting said CAD data into power supply island pattern data, element data, lead pattern data, and via pattern data;
a step of extracting, if two power supply islands existing in two different layers, respectively, overlap each other, said two power supply islands as a power supply pair;
a step of positioning plural nodes on a power supply pair region which is occupied by each power supply pair on a plane of said circuit board;
a step of determining node regions surrounding said nodes, respectively;
a step of determining impedance parameters expressing relationships between said nodes, respectively;
a step of connecting said nodes to each other using said impedance parameters, to generate a power supply layer model; and
a step of connecting said power supply layer model, said lead pattern data, and said via pattern data to one another to generate a power supply noise analysis model.

18. The power supply noise analysis model generation method according to claim 17, wherein said impedance parameters are a reactance L, a resistance R, and an interlayer capacitance C.

19. The power supply noise analysis model generation method according to claim 17, wherein in said step of extracting a power supply pair, if a power supply pair space sandwiched between power supplies of an observed power supply pair is contacted or overlapped by another power supply pair space of any other power supply pair, said observed power supply pair and said other power supply pair are made into a group.

20. The power supply noise analysis model generation method according to claim 17, further comprising a step of positioning, on said power supply pair region, ripples which are wave fronts of electromagnetic waves radiated into said power supply pair region from said elements, wherein in said step of positioning plural nodes, said nodes are positioned based on pitches of said ripples.

21. The power supply noise analysis model generation method according to claim 20, wherein in said step of positioning ripples, rising or falling times of those of said elements which are mounted on said power supply pair region, maximum operating frequencies of those elements, and areas of regions of said ripples are used to calculate said ripples.

22. The power supply noise analysis model generation method according to claim 20, wherein in said step of positioning ripples, said ripples are spread into power supply pair regions of power supply pairs which belong to a group.

23. The power supply noise analysis model generation method according to claim 20, further comprising a step of searching for outline coordinates of said ripples, and displaying said ripples with the use of said outline coordinates.

24. The power supply noise analysis model generation method according to claim 17, further comprising a step of dividing said power supply pair region with the use of meshes based on a wavelength of one of said elements mounted that has the highest operating frequency.

25. The power supply noise analysis model generation method according to claim 24, further comprising a step of storing information for every of said meshes into a table on which coordinates on said circuit board correspond to addresses.

26. The power supply noise analysis model generation method according to claim 25, wherein said information for every of said meshes includes at least one of a ripple level which indicates the number of ripples from an element to a corresponding mesh, the presence or absence of a node in said corresponding mesh, and a node region identifier expressing a node region to which said corresponding mesh belongs.

27. A power supply noise analysis model generation method of modeling a power supply layer in a circuit board, said method comprising:
a step of extracting, as a power supply pair, different two power supply layers overlapping each other in a layering direction from data indicative of said circuit board; and
a step of generating a power supply noise analysis model by using said power supply pair thus extracted.

28. A power supply noise analysis model generation program stored in a medium readable by a computer to make said computer execute modeling power supply layers in a circuit board, said program being operable to make the computer execute:
a step of obtaining CAD data including information concerning a board shape, pattern shapes, and elements;
a step of converting said CAD data into power supply island pattern data, element data, lead pattern data, and via pattern data;
a step of extracting, if two power supply islands existing in two different layers, respectively, overlap each other, said two power supply islands as a power supply pair;
a step of positioning plural nodes on a power supply pair region which is occupied by each power supply pair on a plane of said circuit board;
a step of determining node regions surrounding said nodes, respectively;
a step of determining impedance parameters expressing relationships between said nodes, respectively;
a step of connecting said nodes to each other using said impedance parameters, to generate a power supply layer model; and
a step of connecting said power supply layer model, said lead pattern data, and said via pattern data to one another to generate a power supply noise analysis model.

29. The power supply noise analysis model generation program according to claim 28, wherein said impedance parameters are a reactance L, a resistance R, and an interlayer capacitance C.

30. The power supply noise analysis model generation program according to claim 28, wherein in said step of extracting a power supply pair, if a power supply pair space sandwiched between power supplies of an observed power supply pair is contacted or overlapped by another power supply pair space of any other power supply pair, said observed power supply pair and said other power supply pair are made into a group.

31. The power supply noise analysis model generation program according to claim 28, further comprising a step of making said computer execute positioning, on said power supply pair region, ripples which are wave fronts of electromagnetic waves radiated into said power supply pair region from said elements, wherein in said step of positioning plural nodes, said nodes are positioned based on pitches of said ripples.

32. The power supply noise analysis model generation program according to claim 31, wherein in said step of positioning ripples, rising or falling times of those of said elements which are mounted on said power supply pair region, maximum operating frequencies of those elements, and areas of regions of said ripples are used to calculate said ripples.

33. The power supply noise analysis model generation program according to claim 31, wherein in said step of positioning ripples, said ripples are spread into power supply pair regions of power supply pairs which belong to a group.

34. The power supply noise analysis model generation program according to claim 31, further comprising a step of making said computer execute searching for outline coordinates of said ripples, and displaying said ripples with the use of said outline coordinates.

35. The power supply noise analysis model generation program according to claim 28, further comprising a step of making said computer execute dividing said power supply pair region with the use of meshes based on a wavelength of one of said elements mounted that has the highest operating frequency.

36. The power supply noise analysis model generation program according to claim 35, further comprising a step of making said computer execute storing information for every of said meshes into a table on which coordinates on said circuit board correspond to addresses.

37. The power supply noise analysis model generation program according to claim 36, wherein said information for every of said meshes includes at least one of a ripple level which indicates the number of ripples from an element to a corresponding mesh, the presence or absence of a node in said corresponding mesh, and a node region identifier expressing a node region to which said corresponding mesh belongs.

38. The power supply noise analysis model generation program stored in a medium readable by a computer to make said computer execute modeling a power supply layer in a circuit board, said program being operable to make said computer execute:
a step of extracting, as a power supply pair, different two power supply layers overlapping each other in a layering direction from data indicative of said circuit board; and
a step of using said power supply pair thus extracted, to generate a power supply noise analysis model.
